(19) United States
(12) Patent Application Publication
(10) Pub. No.: US 2013/0095773 A1
(43) Pub. Date: Apr. 18, 2013

(54) Cell phone with light emitter and light receiver

(71) Applicant: Pin Long, LaSalle (CA)

(72) Inventor: Pin Long, LaSalle (CA)

(21) Appl. No.: 13/317,343

(22) Filed: Oct. 17, 2011

(51) Int. Cl. H04W 88/02

(52) U.S. Cl. 455/74

(57) ABSTRACT

A cell phone having not only radio frequency (RF) emitter and RF receiver but also having light emitter and light receiver works together with an earphone having not only speaker and microphone but also having light emitter and light receiver. User will talk or listen with the earphone and cell phone will connect the system to the wireless communication network using RF signal. Communication between cell phone and earphone is carried out using light-wave in free space. By using light-wave based earphone to communicate with cell phone; users becomes less exposed to RF radiations.

### BACKGROUND

4 billion people in the world own mobile phone and many of these cell phone users are children. Wireless cell phones transmit signals via radio frequency (RF), the same kind of low-frequency radiation used in microwave ovens and AM/FM radios. It is well-studied and proven that large doses of high-frequency radiation—the kind used in X-rays—causes cancer, but less is understood about the risks of low-frequency radiation. Studies on the health risks of cell-phone use have produced mixed results, but scientists and medical experts warn that people should not assume no risk exists.

Because cell phones haven't been around very long, scientists haven't been able to assess the effects of long-term cell-phone use, or to study the effects of low-frequency radiation on growing children. Most studies have focused on people who have been using cell phones for three to five years, but some studies have indicated that using a cell phone an hour a day for 10 years or more can significantly increase the risk of developing a rare brain tumor. In December 2007, Israeli researchers reported in the American Journal of Epidemiology that long-term cell-phone users who live in rural areas face a “consistently elevated risk” of developing tumors in the parotid gland compared with users who live in urban or suburban locations. The parotid gland is a salivary gland located just below a person's ear.

And in January 2008, the French Health Ministry issued a warning against excessive cell phone use, especially by children, despite the lack of conclusive scientific evidence linking cell-phone use with cancer or other serious health effects. In a public statement, the ministry said: “As the hypothesis of a risk cannot be entirely excluded, precaution is justified.”

“Precaution” seems to be the approach recommended by an increasing number of scientists, medical experts and public health agencies, from the French Health Ministry to the U.S. Food and Drug Administration (FDA). General recommendations to minimize the potential health risks include talking on cell phones only when necessary, and using a hands-free device to keep the cell phone away from your head.

One way to reduce RF radiation on the human body is to use wired earphone connected with the cell phone and to keep the cell phone away from user's ear. But it is not convenient to use conventional earphone since the earphone has to connect to cell phone with a wire.

Light wave spectrum, from visible to infrared, has low harm for the human body especially at low energy level. Most common device which emits light wave spectrum is laser diode or light-emitting device (LED). Light wave spectrum has been used for telecommunication. For example, most communication pipe lines are optical fiber cables which uses near infrared light wave spectrum (0.85 um, 1.3 um and 1.55 um).

another example is free space optical communication system which used laser beam to carry signals for communication between two points such as two satellites in space or two big buildings in a city.

### OBJECTS OF THE INVENTION

One object of this invention is to provide a no-RF-radiation earphone to the cell phone user in order to reduce the RF radiation on person who uses the cell phone;

One another object of this invention is to use light wave for communication between cell phone and ear phone;

One another object of this invention is that people speak and listen with an earphone while leave cell phone nearby which communicates with RF station as regular cell phone does.

One another object of this invention is that earphone has optical emitter and optical receiver and cell phone has optical emitter and optical receiver for send and receive light wave signal.

One another object of this invention is that optical emitter in cell phone and earphone can be laser diode or light-emitting device (LED).

One another object of this invention is that optical receiver in cell phone and earphone can be photo diode or photo detector.

### BRIEF DESCRIPTION OF THE DRAWINGS

FIG. 1. A cell phone, having not only RF emitter and receiver but also having light emitter and receiver, communicates with an earphone having not only speaker and microphone but also having light emitter and receiver together by using light wave.

FIG. 2. An earphone phone, having not only speaker and microphone but also having light emitter and receiver, communicates with a cell phone having not only RF emitter and RF receiver but also having light emitter and receiver together by using light wave.

FIG. 3. A hand holder phone, having not only speaker and microphone but also having light emitter and receiver, communicates with a cell phone having not only RF emitter and RF receiver but also having light emitter and receiver together by using light wave.

### DETAILED DESCRIPTION

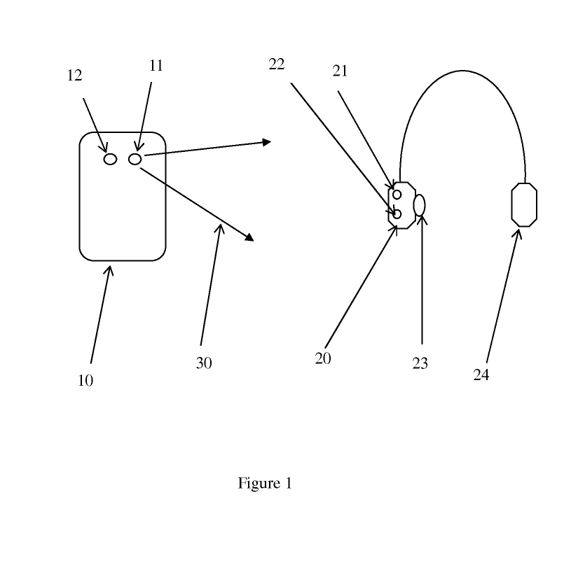

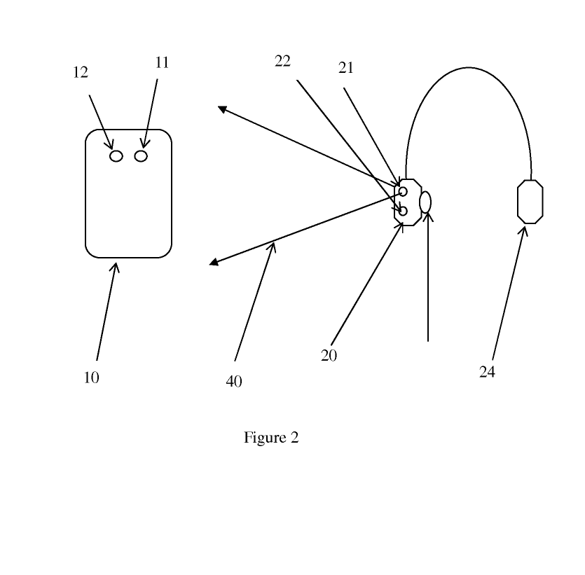

A cell phone, having not only RF emitter and receiver but also having light emitter 11 and receiver 12, works with an earphone having not only speaker 23 and microphone 24 but also having light emitter 21 and receiver 22 together. Microprocessor, electronics circuit and software in cell phone control and coordinate RF emitter, RF receiver, light emitter and light receiver. RF signal received by cell phone is converted into optical signal which is sent out via light emitter 11 in the cell phone 10 as shown in FIG. 1. Optical signal sent out by the light emitter in cell phone 11 is a divergent beam 30 which can cover a large area. Light receiver 22 in ear phone can easily receive optical signal 30 and transfers optical signal into electronics signal which is then converted to sound by the speaker in earphone. Microprocessor, electronic circuits and software in ear phone control and coordinate light emitter, light receiver, microphone and speaker. Since the earphone speaker is placed close to human ear, people can hear voice sound coming from speaker of earphone very easily. When people talk with microphone 24 in the earphone 20, the microphone 24 converts sound into electronics signal which is then transferred into optical signal to be sent out via light emitter 21 in the earphone 20. As light wave signal coming from light emitter 21 in earphone 20 is also a divergent beam 40, the light receiver 12 in cell phone 10 can easily receive optical signal 40 as shown in FIG. 2. Cell phone 10 transforms optical signal received by receiver 22 into electronics signal which is then converted into RF signal sent out via RF emitter to near RF station as the same way as regular cell phone does. Because the cell phone with RF radiation is not close to human head and people speak and listen with earphone without RF radiation, there is much low RF radiation for human body especially human head.

Laser diode and light-emitting device (LED) is most common and small size light wave emitter. Visible light wave spectrum is from 380 nm to 750 nm and infrared light wave spectrum of between 750 nm and 1750 nm is most used for optical communication. At low energy level of visible light wave and infrared light wave have no harm to human eyes and human body. Laser diode and LED are very good light emitter for this invention. New types of laser diode like vertical-external-cavity surface-emitting-laser (VESCEL) and new types of LED like organic light-emitting device (OLED) can also be used for this invention as light emitter. Photodetectors are sensors of light are used in this invention as light wave receiver. There are many different photodetectors like photoresistors, photovoltaic cells, photomultiplier tubes and photodidodes.

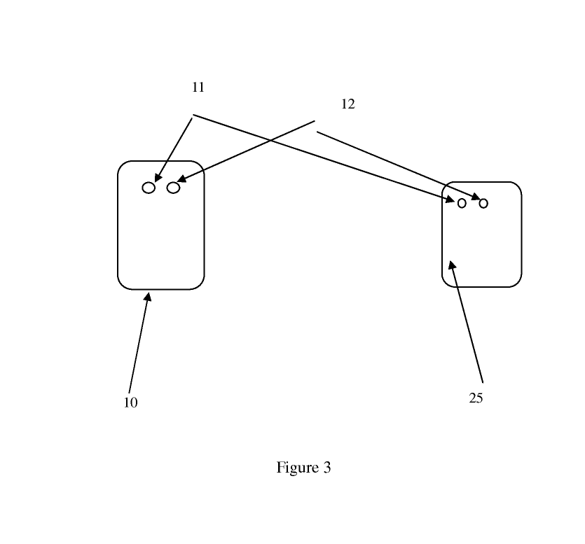

A hand hold phone 25 looks like cell phone with light emitter and light receiver but without RF emitter and RF receiver can also be used to communicate with a cell phone having not only RF emitter and receiver but also having light emitter 11 and receiver 12 as shown in FIG. 3. Microprocessor, electronic circuit and software in hand hold phone control and coordinate light emitter, light receiver, microphone and speaker work together. Unlike earphones which need to be placed near ear, the hand hold phone can be placed any where for example in cloth pocket as a regular cell phone does. As same as earphone, the hand hold phone has not only speaker and microphone but also light emitter and light receiver. When there is a phone call coming in, the light emitter in cell phone sends optical signal to the light receiver in the hand hold phone and the hand hold phone converts the optical signal from the cell phone into electronic signal which is converted into voice by speaker in hand hold phone. When people talk with hand hold phone, the microphone converts voice sound into electronic signal which is sent to light emitter to convert to light signal. The light signal from hand hold phone is sent to cell phone light receiver. Finally the RF emitter sends the RF signal converted from light signal to RF station nearby.

We claim:

1. a cell phone, in addition of having RF emitter and receiver, having light emitter and light receiver communicates with a ear phone having light emitter and light receiver, in additional of having a speaker and a microphone;

2. as in claim 1, light emitter in cell phone sends optical signal to light receiver in earphone and light receiver in cell phone receives optical signal from light emitter in ear phone;

3. as in claim 1, Microprocessor, electronics circuit and software in cell phone coordinate the light emitter, light receiver, RF emitter and RF receiver and make them work together;

4. as in claim 1, light emitter in earphone sends optical signal to the light receiver in cell phone and light receiver in earphone receives optical signal from light emitter in cell phone;

5. as in claim 1, Microprocessor, electronics circuit and software in earphone phone coordinate the light emitter, light receiver, RF emitter and RF receiver and make them work together;

6. as in claim 1, light emitter in cell phone and ear phone is a laser diode, or a light emission device (LED) while light receiver is a photo diode or a photo detector.

7. as in claim 1, cell phone receives and transmit the RF(radio frequency) signal with RF antenna station as regular cell phone does;

8. as in claim 1, RF signal received by cell phone is converted to optical signal which is sent to earphone via light emitter in cell phone;

9. as in claim 1, optical signal received by earphone is converted into voice (or sound) via a micro phone in the ear phone to be hear or to be listened;

10. as in claim 1, when people speak with speaker in ear phone, the voice (or sound) is converted first into electrical signal and then electrical signal is converted into optical signal sent to cell phone via the light emitter in earphone;

11. as in claim 1, the ear phone without RF radiation is placed close to human ear as standard earphone does;

12. as in claim 1, the ear phone without RF radiation is used like a regular cell phone and not necessary to be placed close to ear all times.
